(19) United States
(12) Patent Application Publication
(10) Pub. No.: US 2006/0015591 A1
(43) Pub. Date: Jan. 19, 2006

(54) Apparatus and method for intelligent configuration editor

(76) Inventors: Krishnam Raju Datla, Union City, CA (US); Srinivasa Beereddy, Fremont, CA (US); Praveen Vengalam, Mountain View, CA (US); Chandrasekhar Guntakala, Sunnyvale, CA (US); Chandrareddy Manubothu, Santa Clara, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/148,709

(22) Filed: Jun. 8, 2005

Related U.S. Application Data
(60) Provisional application No. 60/521,631, filed on Jun. 8, 2004.

(51) Int. Cl. G06F 15/177

(52) U.S. Cl. 709/220

(57) ABSTRACT

With an intelligent configuration editor a command database is learned in an automatic way for validation of the syntax and the semantics of network device configuration commands, prompting the user for the validity of the same by way of floating windows and applying the same commands on a device of interest. For example, a method provides receiving and storing, in a configuration editing workspace in an electronic digital memory, network device configuration commands associated with a network device type and a command context; validating the commands against a knowledge base of command syntax and command semantics associated with device types and command contexts for the device types; identifying syntax errors and semantic inconsistencies in the received commands; displaying the received commands in a user interface in a first style; and displaying the syntax errors and semantic inconsistencies in a contrasting style.

### PRIORITY CLAIM; CROSS-REFERENCE TO RELATED APPLICATIONS

This application claims benefit of Provisional Appln. 60/521,631, filed Jun. 8, 2004, the entire contents of which is hereby incorporated by reference as if fully set forth herein, under 35 U.S.C. §119(e).

This application is related to co-pending U.S. application Ser. No. 11/012,885, filed Dec. 14, 2004, entitled “Method and System for Automatically Determining Commands for a Network Element,” of Krishnam R. Datla et al. This application is related to US application no. [number], filed Jun. 8, 2005, of Krishnam Raju Datla et al., entitled “Method and Apparatus for Data Model Prediction,” Attorney Docket No. 50325-1109; US application no. [number], filed Jun. 8, 2005, of Krishnam Raju Datla et al., entitled “Apparatus and Method for Programmable Network Intelligence,” Attorney Docket No. 50325-1105; US application no. [number], filed Jun. 8, 2005, of Krishnam Raju Datla et al., entitled “Method and Apparatus Providing Unified Compliant Network Audit,” Attorney Docket No. 50325-1103; and US application no. [number], filed Jun. 8, 2005, of Krishnam Raju Datla et al., entitled “Configuration Syntax and Semantic Validation,” Attorney Docket No. 50325-1107.

### FIELD OF THE INVENTION

The present invention generally relates to computer network management. The invention relates more specifically to approaches for creating and provisioning configuration information for network devices such as routers and switches.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

A typical network device, such as a router or switch, provides a command interface that is accessible using character-based commands through Telnet, Secure Shell (SSH) and a serial port interface for changing the device status or configuration. Each configuration command has an associated syntax with that. A Network Management Station (NMS) can use these configuration commands to provide a higher level or enhanced management capability to the network operator. To do so, a NMS requires knowledge of the device configuration commands and the syntax of the commands to accomplish changing the configuration of a device.

One way of provisioning a configuration on a device is to issue one or more commands manually. In a large network consisting of many devices of various kinds, the manual approach is cumbersome. Further, human operators may find it impossible to remember the syntax and semantics associated with each kind of device and for each type of configuration. Each device on each interface or task may require different configuration command and the semantics for each may vary. In addition, even in similar types of devices, such as routers or switches, different vendors may adopt different standards, making the task even more complex.

Based on the foregoing, there is a clear need for improved approaches for configuring network devices.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a view of a graphical user interface generated by a Configuration Editor;

FIG. 2 is an example of interpretation of commands in the Configuration Editor;

FIG. 3 is an example of a floating window that enables the user to obtain either a parent view or give a command that is applicable in the current command context;

FIG. 4 is a block diagram of a network management station in which an embodiment may be used;

FIG. 5 is a screen display diagram showing functions for saving a configuration;

FIG. 6 is a screen display diagram showing functions for applying a configuration to a device;

FIG. 7A is a screen display diagram showing output from a configuration comparison function;

FIG. 7B is a screen display diagram showing other output from a configuration comparison;

FIG. 8 is a screen display diagram showing a dialog for applying a configuration;

FIG. 9 is a block diagram that illustrates a computer system upon which an embodiment may be implemented.

### DETAILED DESCRIPTION

A method and apparatus providing an intelligent configuration editor is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Configuration Editor
   2.1 Structural and Functional Overview
   2.2 Configuration Editor User Interface
   2.3 Saving and Applying Configuration
   2.4 Configuration Comparisons
3.0 Implementation Mechanisms-Hardware Overview
4.0 Extensions and Alternatives
   1.0 General Overview

The needs identified in the foregoing Background, and other needs and objects that will become apparent for the following description, are achieved in the present invention, which comprises, in one aspect, a method that provides receiving and storing, in a configuration editing workspace in an electronic digital memory, network device configuration commands associated with a network device type and a command context; validating the commands against a knowledge base of command syntax and command semantics associated with device types and command contexts for the device types; identifying syntax errors and semantic inconsistencies in the received commands; displaying the received commands in a user interface in a first style; and displaying the syntax errors and semantic inconsistencies in a contrasting style.

According to one feature, the method further involves interpreting the commands based on the knowledge base; identifying one or more additional commands that are needed for the received commands to operate properly in the specified network device type and command context; and automatically adding the additional commands to the configuration editing workspace. In one feature, the additional commands are displayed in an additional contrasting style. In another feature, the additional commands are automatically added to the configuration commands in syntactically and semantically correct locations in the workspace.

In still another feature, a list of sub-commands that are allowed in a particular command sub-mode are displayed when one of the received commands would enter the particular command sub-mode when executed in the specified network device type. In one feature, the list is displayed in a floating window over the workspace.

In yet another feature, configuration commands in the configuration editing workspace are saved to a running configuration of a specified network device in response to receiving user input selecting a save command. In still another feature, configuration commands in the configuration editing workspace are saved to a startup configuration of a specified network device in response to receiving user input selecting a save command.

In a further feature, a comparison of configuration commands in a running configuration and a startup configuration of a specified network device is generated and displayed in response to receiving user input selecting a comparison command. In one feature, the comparison identifies a number of changes between the running configuration and the startup configuration. In yet another feature, the comparison shows the running configuration and the startup configuration in a first display style, and shows differences between the running configuration and the startup configuration in a contrasting display style.

In other aspects, the invention encompasses a computer apparatus and a computer-readable medium configured to carry out the foregoing steps.

2.0 Configuration Editor

2.1 Structural and Functional Overview

If an NMS could be provided with a knowledge base for the device type under consideration and complete knowledge regarding the semantics and syntax of the configuration commands, then the knowledge base could be used by the NMS to provide management capability for large number of device types very quickly and efficiently. Also, use of a knowledge base is less error prone compared to the manual entry of the commands.

If the NMS could have a way to intelligently group device types or provide a unified network view in which the whole network is visualized as a single device, then the configuration for a single device could be pushed on to several devices with a single command. This approach would stroke obviating the onus on the Network administrator to logging into each device and pushing the configuration.

All device commands are assumed to follow certain syntax. According to an embodiment, a knowledge base for the commands and the related syntax for each command supported by the device under every view is built using an Auto Learning Mechanism, and the information is kept in a database either in the form of binary or text or XML format. In one embodiment, the Auto Learning Mechanism is implemented using the approaches described in co-pending U.S. application Ser. No. 11/012,885, filed Dec. 14, 2004, entitled “Method and System for Automatically Determining Commands for a Network Element,” of Krishnam R. Datla et al. (“Datla et al.”). There could be exceptions to the allowed syntax. Exceptions are handled using special case handling which can be specific to the family of devices or the functionality/feature.

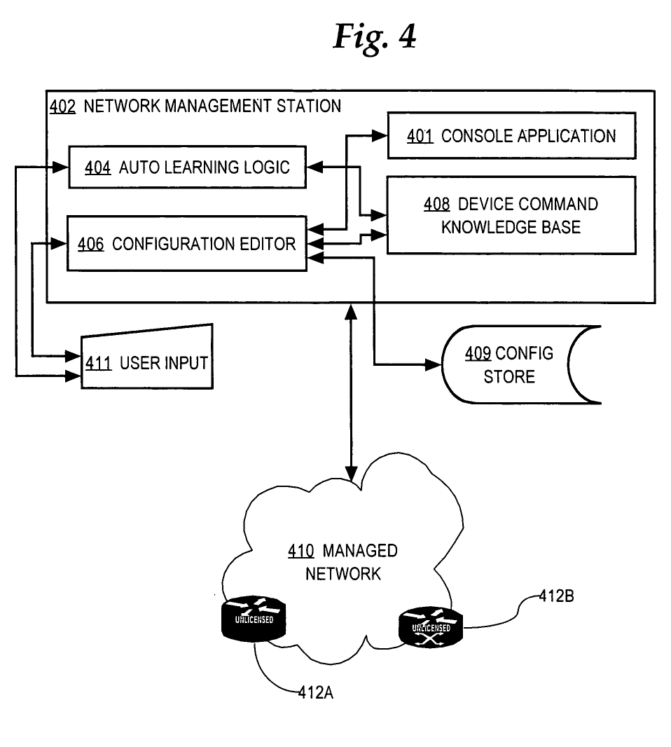

FIG. 4 is a block diagram of a network management station in which an embodiment may be used. A network management station 402 comprises auto learning logic 404, a configuration editor 406, a device command knowledge base 408, and a configuration store 409. Network management station 402 receives user input of configuration commands and configuration editor commands through user input 411. Network management station 402 is coupled to a managed network 410 that includes one or more network devices 412A, 412B, such as routers, switches, etc.

Auto learning logic 404 implements the approaches of Datla et al., and stores a representation of device command syntax in knowledge base 408. Generally, auto learning logic 404 receives configuration commands that are entered through user input 411, interprets responses that are received from managed devices 412A, 412B, such as syntax errors, semantic errors, or acceptance of the commands, and builds a knowledge base 408 that defines a correct syntax of configuration for the devices, organized by device type. Knowledge base 408 may be based, in part, on a pre-configured language specification for a command syntax or language used by one or more devices. The knowledge base 408 may hold information about command syntax for many command languages for many different device types. In an embodiment, knowledge base 408 is a database or directory of XML documents representing command syntax. Each device type and command language is represented in a separate XML document.

Configuration editor 406 creates and stores one or more configuration files, each comprising one or more configuration commands for a particular device or device type, in configuration store 409. The configuration store 409 may comprise disk storage on a personal computer, workstation or server. Configuration files in configuration store 409 may include information identifying whether a particular file represents a startup configuration, running configuration, or other kind of configuration.

Using of a CLI (Command Line Interface) can be a daunting task for configuring a network having many nodes. In one embodiment, the configuration editor 406 is used for editing the configuration of a device. Configuration editor 406 enables a user to store all related commands in one place in a named file. Further, configuration editor 406 can is capable of interpreting commands to determine their syntax and semantics. The configuration editor 406 can push the same configuration file to each device in a group of devices based on capabilities.

A network device, such as devices 412A, 412B of FIG. 4, may have multiple command views. For example, when a particular command executes, the device command context switches to a new command view. The new view typically contains different commands than the commands present in the previous view (or “parent view”). The new view may also contain the same commands, but with different parameters. The commands executed at any particular view generally are used for either eliciting some information from the device, or to change the configuration of the device as described above. Any type of command in general would have a structure and can be validated against the result when the same is executed on the device.

The structure of any command can be visualized as a logical tree. For example, a typical command is “Keyword parameter1 value1 parameter2 value2”. A root node of a tree can represent a command keyword. After the command keyword, there can be many options that may be associated with the root node, represented by child nodes in the tree, and when the user traverses to that node there can be some more options or input may be required. When the command completes, the command exits, normally either showing some form of output, or if the command is for a configuration change, then the change is performed.

If the command is not valid in any mode, then the command either simply exits or gives an error message. Network devices generally do not include intelligence to notify a user whether a command that is being executed on that device is correct or not until the user applies the command. By that time the user learns that the syntax typed is wrong, the mistake is done, and the user has to type the entire command again. If the NMS could acquire command syntax knowledge based on monitoring commands typed by the user, and error messages received from the device indicating invalid syntax, the NMS could potentially assist the user.

In one embodiment, auto learning logic 404 of FIG. 4 includes or is coupled to a Syntax and Semantic validation engine that implements the approaches described in co-pending U.S. provisional application 60/521,634, filed Jun. 8, 2004, and nonprovisional application [Number], filed Jun. 8, 2005, Attorney Docket No. 50325-1107. The Syntax and Semantic validation engine acquires knowledge of configuration commands by interpreting the keystrokes at runtime. In one embodiment, based on information received from auto learning logic 404, configuration editor 406 informs a user that the syntax of a command is wrong by changing the color of the typed letters into red at the point at which the syntax is incorrect.

In another feature, configuration editor 406 interoperates with knowledge base 408 to show a drop-down list of all commands that can be used or are applicable when the editor is displaying a particular view or context. Accordingly, when the editor is displaying a particular view or context, the user receives cues about which commands are valid in the view or context.

Configuration editor 406 may display a list of device groups or device types. The user may select a particular device type from the list. In response to the user selecting a particular device type from the list of the device groups, configuration editor 406 editor becomes context-sensitive with respect to the group or type of that device, since a particular group of devices will have same commands.

In an embodiment, configuration editor 406 enables a user to search within an active configuration document to locate particular commands. In an embodiment, configuration editor 406 enables a user to save a configuration file to any specified location. Based on the device command intelligence learned from the Syntax and Semantic validation engine, configuration editor 406 also can assist in creating and applying an incremental configuration to running devices.

In an embodiment, based on knowledge base 408, configuration editor 406 can determine and send to a device commands not stated in a configuration file but that depend from commands that are in the configuration file. Thus, the configuration editor 408 can push to a device those commands that are necessary but not found in the commands created or stored using the editor. For example, assume that a user creates a configuration file that gives the command “hostname AP1” to a wireless access point having a current host name “ap.” The “hostname AP1” command is interpreted as the two commands “no hostname ap” and then “hostname AP1”, and both commands are sent to the device. The first command nullifies the previous host name and the second command pushes the new host name.

2.2 Configuration Editor User Interface

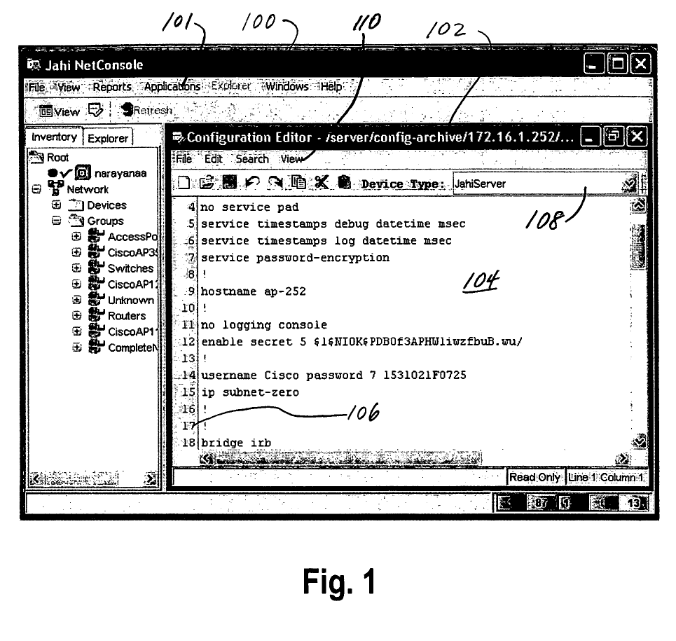

FIG. 1 is a view of a user interface display for a Configuration Editor. A graphical user interface display 100 of a console application 401 provides a command toolbar 101 from which a user may launch the configuration editor 406. In response, configuration editor 406 generates and displays an editor window 102 that includes a command pane 104, line numbers 106, device type pull-down 108 and toolbar 110.

The command pane 104 provides a workspace within which a user may enter one or more lines of a device configuration. Line numbers 106 identify discrete lines of configuration. Device type pull-down 108 includes entries for each device type that the configuration editor 406 recognizes, based upon knowledge base 408 or upon a configuration file for the configuration editor.

Toolbar 110 provides access to file manipulation, editing, search, and view functions of the configuration editor 406, which are described further herein. In one embodiment, the Search functions enable a user to search forward or backward in a configuration file for a specified text string or symbol.

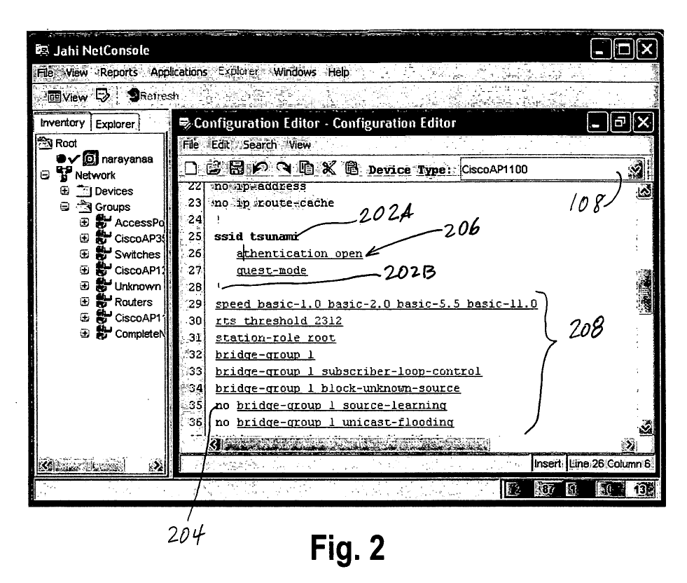

FIG. 2 is an example of interpretation of commands in the Configuration Editor. In the example of FIG. 2, a different device type has been selected with device type pull-down 108. A user has typed the command “ssid tsunami” 202A followed by a comment symbol 202B. In response, configuration editor 406 has interpreted the typed commands and inserted additional commands 206 that are required to make the typed commands syntactically and semantically correct for the device type indicated in pull-down 108. Similarly, the user typed the commands “no” 204, and in response, configuration editor 406 inserted additional commands 208 that are required for the typed commands to succeed on the device.

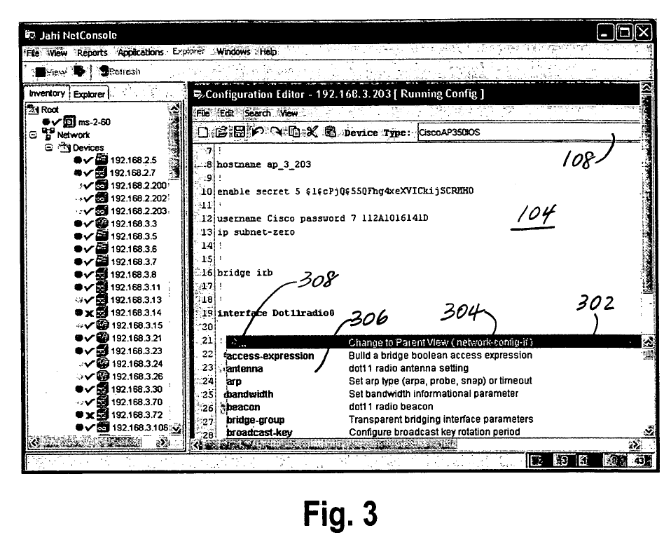

FIG. 3 is an example of a floating window that enables the user to obtain either a parent view or give a command that is applicable in the current command context. In the example of FIG. 3, a user has typed a set of configuration commands in command pane 104. The last entered command was “network-config-if”, which is associated with a separate command context. In response to entry of the command, command editor 406 generates and displays a floating window 302 that includes a title bar indicating the last entered command that cause a context change. Window 302 is displayed graphically over the command pane 104 and any commands therein. Window 302 includes a list 306 of commands that are valid in the current context and descriptions of the commands. Thus, list 306 provides a reference so that a user does not have to remember all sub-commands when changing modes or contexts through commands typed in the pane 104. Window 302 further includes a closing icon 308 which, when selected by user input such as a mouse click, causes the floating window to close and ends the current command context.

2.3 Saving and Applying Configuration

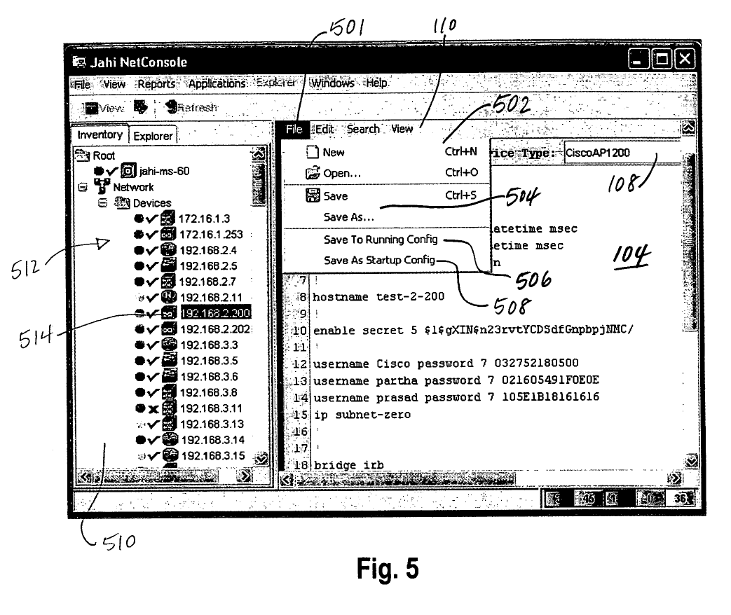

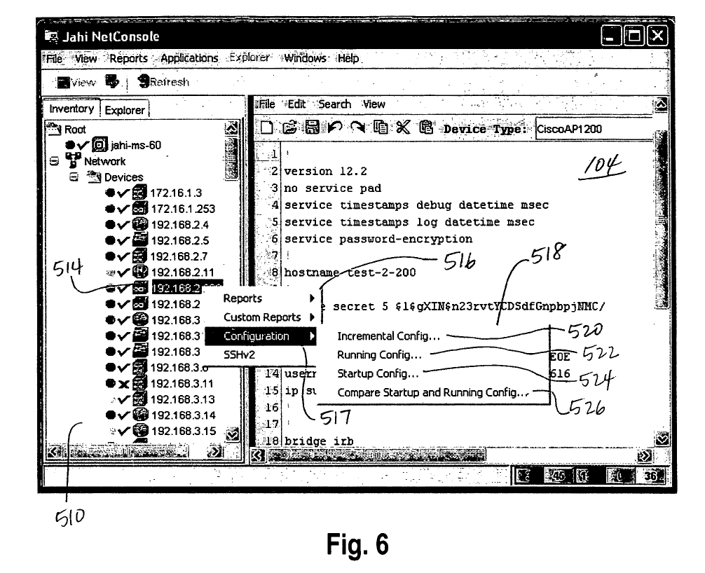

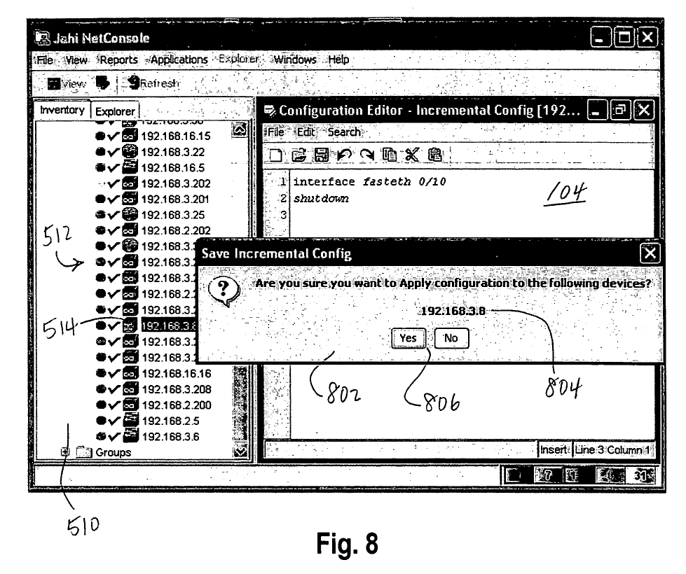

FIG. 5 is a screen display diagram showing functions for saving a configuration, FIG. 6 is a screen display diagram showing functions for applying a configuration to a device, and FIG. 8 is a screen display diagram showing a dialog for applying a configuration. Referring first to FIG. 5, after entering one or more lines of configuration in pane 104, a user may select a File menu 501 using toolbar 110. In response, configuration editor 406 generates and displays a file menu 502 that includes Save and Save As commands 504, a “Save to Running Config” command 506, and “Save As Startup Config” command 508.

Selecting either of the Save and Save As commands 504 enables a user to save the contents of pane 104 to a named file in a local file system of a computer that is hosting configuration editor 406, or to a networked file server. In one embodiment that runs under the MICROSOFT WINDOWS operating system, selecting Save or Save As causes configuration editor 406 to invoke a WINDOWS save file dialog.

In one embodiment, selecting the “Save to Running Config” command 506 causes configuration editor 406 to transfer a copy of the contents of pane 104 to a running configuration of a managed device. For example, configuration editor 406 automatically initiates a telnet connection to the specified device, logs in to the device, and transfers a copy of the configuration shown in pane 104 to the running configuration of the specified device. In one embodiment, configuration editor 406 communicates with or is integrated into a management console application that generates an inventory window 510 comprising a tree representation 512 of managed devices in a network. Selecting an address 514 representing a particular device specifies that the save commands 506, 508 apply to the selected device. Although the embodiment of FIG. 5 shows address 514 to identify a device, in alternate embodiments a device name or other identifier may be used in inventory window 510.

To support this function, a telnet port number, account name, and password are stored in the configuration editor 406 in advance using a configuration function for the configuration editor. Selecting the “Save As Startup Config” command 508 similarly causes configuration editor 406 to save a copy of the contents of pane 104 to the device indicated by the selected address 514.

Referring now to FIG. 6, which is a screen display diagram that shows functions for applying a configuration to a device, in one embodiment, selecting an address 514 of a device in inventory window 510, followed by providing an alternate selection user input, causes configuration editor 406 to display a pop-up menu 516 that includes a configuration command 517. An example of alternate selection user input is right clicking with a mouse or other pointing device after selecting the address 514. Selecting configuration command 517 causes configuration editor 406 to display a menu 518 of configuration commands.

In one embodiment, menu 518 includes an Incremental Configuration command 520, Running Configuration command 522, Startup Configuration command 524, and Compare command 526. Selecting the Incremental Configuration command 520 causes configuration editor 504 to apply the contents of pane 104 as an incremental configuration for the device having selected address 514. Selecting the Running Configuration command 522 causes configuration editor 504 to apply the contents of pane 104 as the running configuration of the device having selected address 514. Selecting the Startup Configuration command 524 causes configuration editor 504 to apply the contents of pane 104 as the startup configuration of the device having selected address 514. The Compare command 526 is described in the next section.

In all such configuration options, configuration editor 406 may use a telnet session with pre-configured parameters to transfer a copy of the contents of pane 104 to the specified device. Further, in all such configuration options, configuration editor 406 may require a user to confirm the operation before configuration is actually transferred to the device. FIG. 8 is a screen display diagram showing a dialog for applying a configuration. In one embodiment, when a user selects the Incremental Configuration command 520, Running Configuration command 522, or Startup Configuration command 524, configuration editor 406 generates and displays a confirmation dialog box 802 that requests the user to confirm applying the configuration to the specified device. Box 802 includes a device identifier 804 that matches the selected address 514 and confirmation buttons 806. Selecting a YES button or the equivalent causes configuration editor 406 to proceed with the requested configuration command. Selecting a NO button or the equivalent cancels the requested command.

2.4 Configuration Comparisons

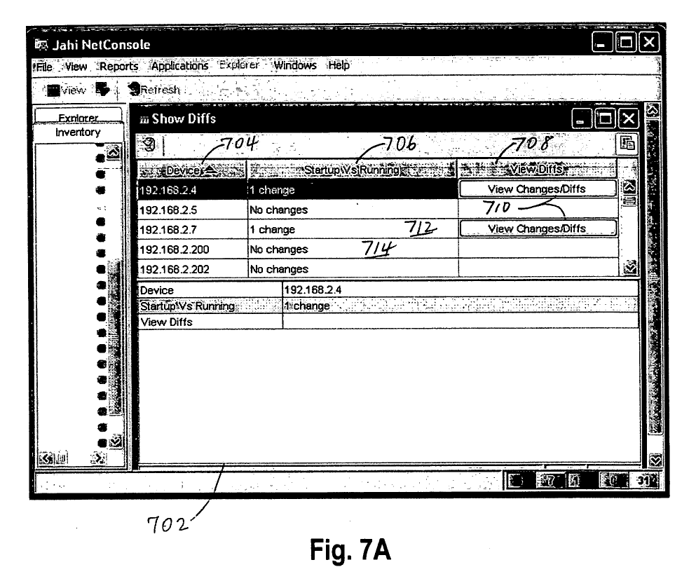

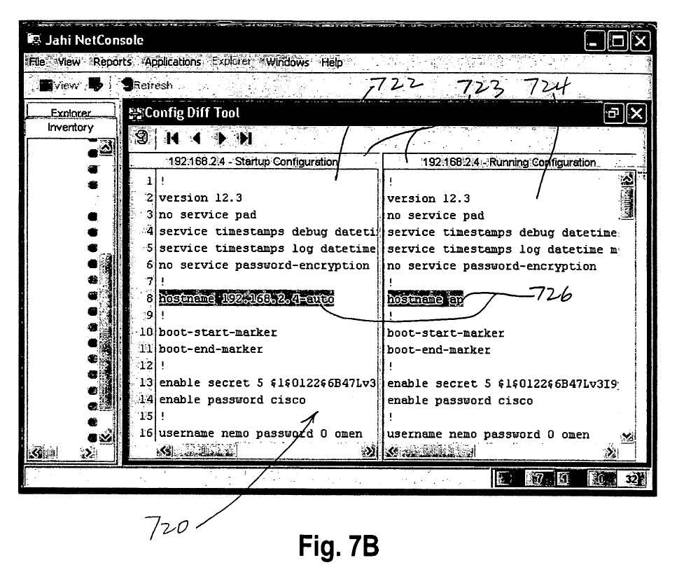

Selecting the Compare command 526 of FIG. 6 invokes a configuration comparison operation of configuration editor 406. FIG. 7A is a screen display diagram showing output from a configuration comparison function; FIG. 7B is a screen display diagram showing other output from a configuration comparison. Referring first to FIG. 7A, selecting a specified device using an address 514 (FIG. 6) and selecting the Compare command 526 causes configuration editor 406 to generate and display a difference display window 702 comprising a device column 704, comparison column 706, and view button column 708.

The device column 704 lists devices for which configuration comparisons have been performed, by address or other identifier. Comparison column 706 indicates the number of changes that have been identified in a text comparison of the startup configuration of the specified device and the running configuration of the specified device. If one or more change is found, then view button column 708 includes a selectable view button 710. For example, in FIG. 7A, device 192.168.2.7 has one change in the configurations, as indicated by the designation “1 change” 712, and therefore a view button 710 is displayed. Conversely, device 192.168.2.200 has no changes, as indicated by the designation “No changes” 714, and therefore no view button is displayed.

Selecting a view button 710 for a specified device causes configuration editor 406 to display a comparison view 720 that displays, side by side, a startup configuration 722 and running configuration 724 for the device, as indicated by title bars 723. Changes in the respective configurations are shown with highlighting, as indicated for configuration line 726. Accordingly, a user can rapidly and automatically identify differences in configuration files, which may comprise hundreds or thousands of lines.

3.0 Implementation Mechanisms—Hardware Overview

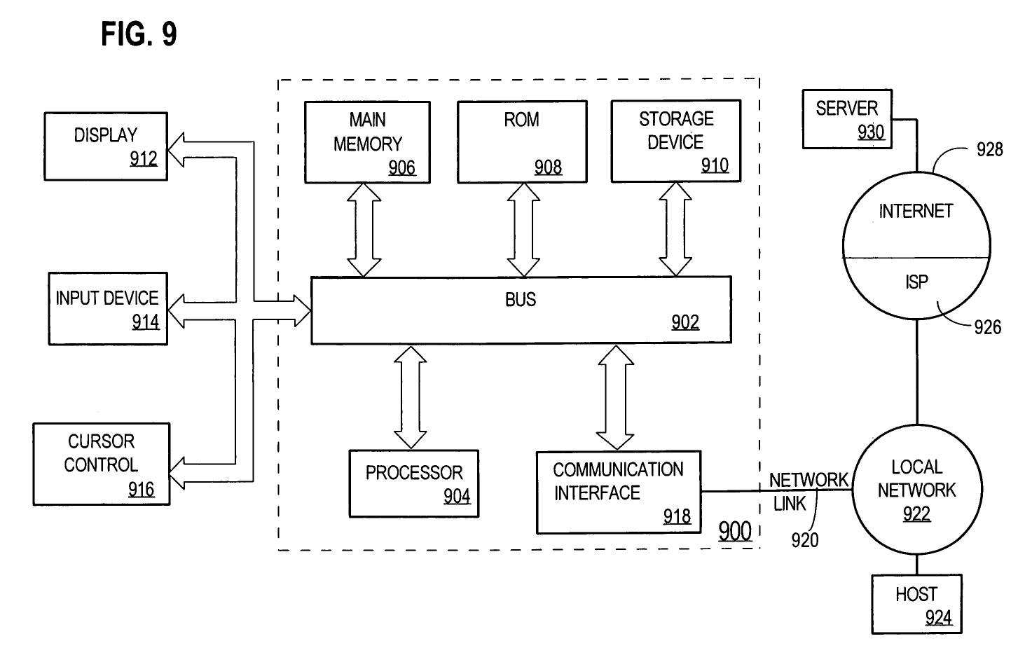

FIG. 9 is a block diagram that illustrates a computer system 900 upon which an embodiment of the invention may be implemented. Computer system 900 includes a bus 902 or other communication mechanism for communicating information, and a processor 904 coupled with bus 902 for processing information. Computer system 900 also includes a main memory 906, such as a random access memory (“RAM”) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (“ROM”) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (“CRT”), for displaying information to a computer user. An input device 914, including alphanumeric and other keys, is coupled to bus 902 for communicating information and command selections to processor 904. Another type of user input device is cursor control 916, such as a mouse, trackball, stylus, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for an intelligent configuration editor. According to one embodiment of the invention, an intelligent configuration editor is provided by computer system 900 in response to processor 904 executing one or more sequences of one or more instructions contained in main memory 906. Such instructions may be read into main memory 906 from another computer-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infrared transmitter to convert the data to an infrared signal. An infrared detector can receive the data carried in the infrared signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (“ISDN”) card or a modem to provide a data communication connection to a corresponding type of telephone line. As another example, communication interface 918 may be a local area network (“LAN”) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (“ISP”) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. In accordance with the invention, one such downloaded application provides for an intelligent configuration editor as described herein.

The received code may be executed by processor 904 as it is received, and/or stored in storage device 910, or other non-volatile storage for later execution. In this manner, computer system 900 may obtain application code in the form of a carrier wave.

4.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. An apparatus, comprising:
one or more processors;
an electronic digital memory coupled to the one or more processors;
one or more program instructions stored in the memory, which instructions, when executed by the one or more processors, cause the one or more processors to perform the steps of:
receiving and storing, in a configuration editing workspace in the memory, one or more network device configuration commands associated with a network device type and a command context;
validating the commands against a knowledge base of command syntax and command semantics associated with one or more device types and one or more command contexts for the device types;
identifying any of one or more syntax errors and one or more semantic inconsistencies in the received commands;
displaying the received commands in a user interface in a first style; and
displaying the syntax errors and semantic inconsistencies in a contrasting style.

2. An apparatus as recited in claim 1, further comprising additional program instructions stored in the memory, which instructions, when executed by the one or more processors, cause the one or more processors to perform the steps of interpreting the commands based on the knowledge base; identifying one or more additional commands that are needed for the received commands to operate properly in the specified network device type and command context; and automatically adding the additional commands to the configuration editing workspace.

3. An apparatus as recited in claim 2, wherein the additional commands are displayed in an additional contrasting style.

4. An apparatus as recited in claim 2, wherein the additional commands are automatically added to the configuration commands in syntactically and semantically correct locations in the workspace.

5. An apparatus as recited in claim 2, wherein a list of sub-commands that are allowed in a particular command sub-mode are displayed when one of the received commands would enter the particular command sub-mode when executed in the specified network device type.

6. An apparatus as recited in claim 5, wherein the list is displayed in a floating window over the workspace.

7. An apparatus as recited in claim 1, wherein configuration commands in the configuration editing workspace are saved to a running configuration of a specified network device in response to receiving user input selecting a save command.

8. An apparatus as recited in claim 1, wherein configuration commands in the configuration editing workspace are saved to a startup configuration of a specified network device in response to receiving user input selecting a save command.

9. An apparatus as recited in claim 1, wherein a comparison of configuration commands in a running configuration and a startup configuration of a specified network device is generated and displayed in response to receiving user input selecting a comparison command.

10. An apparatus as recited in claim 9, wherein the comparison identifies a number of changes between the running configuration and the startup configuration.

11. An apparatus as recited in claim 9, wherein the comparison shows the running configuration and the startup configuration in a first display style, and shows differences between the running configuration and the startup configuration in a contrasting display style.

12. An apparatus, comprising:
one or more processors;
an electronic digital memory coupled to the one or more processors;
means for receiving and storing, in a configuration editing workspace in the memory, one or more network device configuration commands associated with a network device type and a command context;
means for validating the commands against a knowledge base of command syntax and command semantics associated with one or more device types and one or more command contexts for the device types;
means for identifying any of one or more syntax errors and one or more semantic inconsistencies in the received commands;
means for displaying the received commands in a user interface in a first style; and
means for displaying the syntax errors and semantic inconsistencies in a contrasting style.

13. An apparatus as recited in claim 12, further comprising means for interpreting the commands based on the knowledge base, means for identifying one or more additional commands that are needed for the received commands to operate properly in the specified network device type and command context; and means for automatically adding the additional commands to the configuration editing workspace.

14. An apparatus as recited in claim 13, wherein the additional commands are displayed in an additional contrasting style.

15. An apparatus as recited in claim 13, wherein the additional commands are automatically added to the configuration commands in syntactically and semantically correct locations in the workspace.

16. An apparatus as recited in claim 13, wherein a list of sub-commands that are allowed in a particular command sub-mode are displayed when one of the received commands would enter the particular command sub-mode when executed in the specified network device type.

17. An apparatus as recited in claim 16, wherein the list is displayed in a floating window over the workspace.

18. An apparatus as recited in claim 12, wherein configuration commands in the configuration editing workspace are saved to a running configuration of a specified network device in response to receiving user input selecting a save command.

19. An apparatus as recited in claim 12, wherein configuration commands in the configuration editing workspace are saved to a startup configuration of a specified network device in response to receiving user input selecting a save command.

20. An apparatus as recited in claim 12, wherein a comparison of configuration commands in a running configuration and a startup configuration of a specified network device is generated and displayed in response to receiving user input selecting a comparison command.

21. An apparatus as recited in claim 20, wherein the comparison identifies a number of changes between the running configuration and the startup configuration.

22. An apparatus as recited in claim 20, wherein the comparison shows the running configuration and the startup configuration in a first display style, and shows differences between the running configuration and the startup configuration in a contrasting display style.

23. A method, comprising:
receiving and storing, in a configuration editing workspace in an electronic digital memory, one or more network device configuration commands associated with a network device type and a command context;
validating the commands against a knowledge base of command syntax and command semantics associated with one or more device types and one or more command contexts for the device types;
identifying any of one or more syntax errors and one or more semantic inconsistencies in the received commands;
displaying the received commands in a user interface in a first style; and
displaying the syntax errors and semantic inconsistencies in a contrasting style.

24. A method as recited in claim 23, further comprising additional program instructions stored in the memory, which instructions, when executed by the one or more processors, cause the one or more processors to perform the steps of interpreting the commands based on the knowledge base; identifying one or more additional commands that are needed for the received commands to operate properly in the specified network device type and command context; and automatically adding the additional commands to the configuration editing workspace.

25. A method as recited in claim 24, wherein the additional commands are displayed in an additional contrasting style.

26. A method as recited in claim 24, wherein the additional commands are automatically added to the configuration commands in syntactically and semantically correct locations in the workspace.

27. A method as recited in claim 24, wherein a list of sub-commands that are allowed in a particular command sub-mode are displayed when one of the received commands would enter the particular command sub-mode when executed in the specified network device type.

28. A method as recited in claim 27, wherein the list is displayed in a floating window over the workspace.

29. A method as recited in claim 23, wherein configuration commands in the configuration editing workspace are saved to a running configuration of a specified network device in response to receiving user input selecting a save command.

30. A method as recited in claim 23, wherein configuration commands in the configuration editing workspace are saved to a startup configuration of a specified network device in response to receiving user input selecting a save command.

31. A method as recited in claim 23, wherein a comparison of configuration commands in a running configuration and a startup configuration of a specified network device is generated and displayed in response to receiving user input selecting a comparison command.

32. A method as recited in claim 31, wherein the comparison identifies a number of changes between the running configuration and the startup configuration.

33. A method as recited in claim 31, wherein the comparison shows the running configuration and the startup configuration in a first display style, and shows differences between the running configuration and the startup configuration in a contrasting display style.

34. A computer-readable medium, comprising one or more program instructions stored in the memory, which instructions, when executed by the one or more processors, cause the one or more processors to perform the steps of:
receiving and storing, in a configuration editing workspace in the memory, one or more network device configuration commands associated with a network device type and a command context;
validating the commands against a knowledge base of command syntax and command semantics associated with one or more device types and one or more command contexts for the device types;
identifying any of one or more syntax errors and one or more semantic inconsistencies in the received commands;
displaying the received commands in a user interface in a first style; and
displaying the syntax errors and semantic inconsistencies in a contrasting style.
